(19) United States
(12) Patent Application Publication
(10) Pub. No.: US 2008/0160446 A1
(43) Pub. Date: Jul. 3, 2008

(54) Photoresists including amino acid polymers as photoimageable species

(76) Inventor: Robert P. Meagley, Hillsboro, OR (US)

Correspondence Address: INTEL/BLAKELY, 1279 OAKMEAD PARKWAY, SUNNYVALE, CA, 94085-4040, US

(21) Appl. No.: 11/648,063

(22) Filed: Dec. 28, 2006

(51) Int. Cl. G03C 1/00

(52) U.S. Cl. 430/273.1; 430/281.1

(57) ABSTRACT

Photoresist compositions including amino acid polymers as photoimageable species are disclosed. Methods of using the compositions in photolithography are also disclosed.

### BACKGROUND

1. Field

Embodiments of the invention relate to photolithography to form microelectronic devices. In particular, embodiments of the invention relate to photoresists and their use in photolithography.

2. Background Information

Photolithography is used in the field of integrated circuit processing to form the patterns that will make up the features of an integrated circuit. A patterned photoresist layer may be used as a sacrificial layer to transfer a pattern to an underlying substrate. Patterns may be created in the photoresist layer by exposing the photoresist layer to radiation through a mask. The radiation may be visible light, ultraviolet light, deep ultraviolet light, and extreme ultraviolet (EUV) light, or an electron beam. In the case of a “direct write” electron beam, a mask is not necessary because the features may be drawn directly in the photoresist. The pattern may be used as a template for etching or implanting the substrate, for example.

Various photoresist compositions are known in the arts. One common positive-tone photoresist used with the I, G and H-lines from a mercury-vapor lamp is based on a mixture of diazonaphthoquinone (DNQ) and Novolac resin (a phenol formaldehyde resin). Deep Ultraviolet (DUV) resist are typically polyhydroxystyrene-based polymers with a photo-acid generator providing the solubility change.

There are advantages to developing new and different photoresists.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a structure of one example of a deprotected, developer soluble form of polytyrosine.

FIG. 2 is a block diagram of an amino acid polymer covalently bonded to both a photo-acid generator and a quencher, according to one or more embodiments of the invention.

FIGS. 3a-3i are cross-sectional side views of different structures representing different stages of a method of forming vias, according to one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

In one or more embodiments of the invention, an amino acid polymer may be used as a photoimageable species of a photoresist. As used herein, an amino acid polymer may refer to a protein, peptide, polypeptide, derivative thereof, or other amino acid polymers known in the arts.

Initially, a discussion of amino acids, proteins, peptides, and polypeptides may be helpful. Amino acids are molecules having both a carboxylic acid group and an amine group. Naturally occurring proteins have a central carbon atom, known as the alpha carbon, to which both the carboxylic acid group and the amine group are bonded. A variable side group is also bonded to the alpha carbon. The variable side group differs among the different naturally occurring amino acids, and gives them distinct chemical properties, which they impart to proteins. There are about twenty different naturally occurring amino acids, which are prevalent in nature. These amino acids have L-type chirality and are sometimes known as L-alpha amino acids.

Proteins are amino acid heteropolymers built from the different naturally occurring amino acids. The proteins generally have the amino acids arranged in a linear chain, which is not necessarily straight, but rather may bend, curve, and tangle. The amino acids in the linear chain are linked together by peptide bonds. A peptide bond is a chemical bond formed between a carboxyl group of one amino acid and an amino group of another amino acid. The formation of the peptide bond may release a molecule of water (H2O), and therefore this reaction is sometimes referred to as a dehydration synthesis reaction or a condensation reaction. Once linked in the polymer chain, an individual amino acid is strictly called an amino acid residue, since water has already been “split out”. However, as used herein, this amino acid residue may simply be referred to as an amino acid. The resulting —C(═O)—NH— bond produced by the reaction is a peptide bond, and the resulting molecule is an amide. Sometimes, the four-atom functional group —C(═O)NH— is called an amide group, or commonly in the context of proteins a peptide group. The variable side groups of the amino acids largely direct the proteins three-dimensional structure, properties, and function. The end of the protein with a free carboxyl group is known as the C-terminus or carboxy terminus, while the end with a free amino group is known as the N-terminus or amino terminus.

Peptides and polypeptides are also examples of amino acid polymers. The term protein is generally reserved for relatively large biological molecules, while the term peptide is generally used for short amino acid oligomers often lacking in well-defined secondary structure. The boundary between proteins and peptides is not precisely defined, but may be somewhere between twenty to thirty amino acid residues. As used herein, the term polypeptide may be used to refer to any single linear chain of amino acids, peptide groups, or amide groups, regardless of length, and is intended to encompass peptides and proteins. Similarly, the amino acid polymers referred to herein are not limited to any known length.

Proteins, peptides, polypeptides, and other amino acid polymers may be used as a photoimageable species in a photoresist. Characteristics that are often desired in a photoresist include transparency to an actinic radiation used for exposure, capability of being directly or indirectly transformed upon exposure to the actinic radiation, capability of the transformation to increase or decrease solubility in a developer, and capability of the remaining photoresist after development to have sufficient etch resistance for one or more useful etch chemistries. Various different types of amino acid polymers are capable of exhibiting these characteristics and serving as photoimageable species in photoresists.

There are various ways in which the amino acid polymers may be directly or indirectly transformed upon exposure to the actinic radiation to alter solubility in a developer. As one option, in one or more embodiments of the invention, an amino acid polymer may include an acid labile protecting group, similarly to that applied in a classic chemical amplification approach. The term “protecting group” generally refers to a group, moiety, or other portion of a compound that may block or otherwise protect a functional group or other portion of the amino acid polymer. The protection may help to prevent or at least reduce participation of the functional group in a chemical or solvation reaction. This protection may help to change, often reduce, the dissolution of the amino acid polymer in a developer. Thus, in one aspect, the protecting group may be considered a “dissolution inhibitor”. The term “acid labile” generally implies that the group is capable of being changed, for example cleaved or otherwise detached from the chain, by an acid.

The amino acid polymer may be included in a photoresist composition with a photo-acid generator (PAG) or other species capable of generating an acid upon exposure to radiation. The radiation applied to the photoresist may cause the decomposition of the PAG, which may cause the generation of a small amount of acid catalyst throughout the exposed resist. The acid, once generated, may cause a cascade of chemical reactions either instantly or in a post-exposure bake that increase the solubility of the resist such that the exposed portions of the resist may be removed by a developer. For example, the acid may cleave or remove the acid labile protecting group in a reaction known in the arts as a deprotection reaction. This removal of the protecting group may change, often increase, the solubility of the remaining deprotected amino acid polymer in a developer. The use of such a deprotecting mechanism is well established in the area of chemically amplified resists. A potential advantage of using the chemical amplification approach is that the chemical reactions are catalytically enhanced by the acid, and therefore the acid is regenerated afterwards and may be reused, thereby decreasing the amount of radiation required for pattern formation in the resist and thus enabling the use of shorter wavelengths of light such as EUV that are produced by weaker light sources.

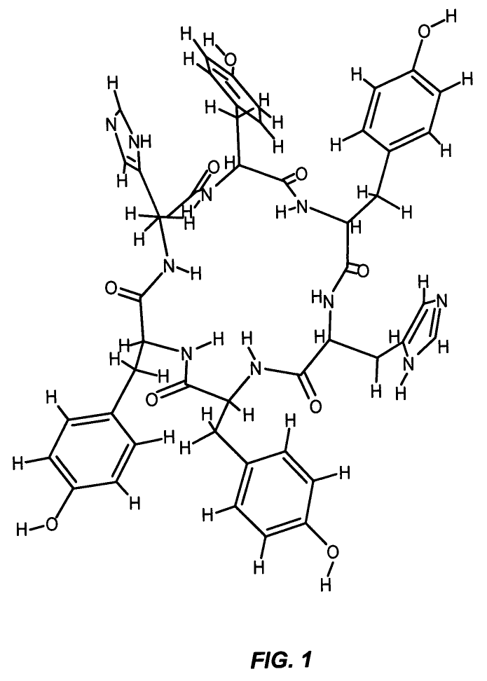

Various examples of suitable amino acid polymers having acid labile protecting groups are known in the arts. One common acid labile protecting group is t-butoxycarbonyl (tBOC). One specific example of a suitable tBOC protected amino acid polymer, according to one or more embodiments of the invention, is tBOC-protected polytyrosine. The tBOC-protected polytyrosine may be deprotected, for example with an acid generated by a photo-acid generator, to produce a developer soluble form. FIG. 1 is a structure of one example of a deprotected, developer soluble form of polytyrosine.

Like the well-known polyhydroxystyrene, polytyrosine is a phenolic polymer. Polyhydroxystyrene has been used successfully in deep ultraviolet (DUV), extreme ultraviolet (EUV), and e-beam photolithography. It may similarly be possible to apply polytyrosine in DUV, EUV, and e-beam photolithography. Polyhydroxystyrene and polytyrosine have similar functional density, solubility and hydrophobicity. Like tBOC-protected polyhydroxystyrene, the tBOC-protected polytyrosine may be converted to a developer soluble deprotected version upon exposure in the presence of a PAG. Development may then be performed, for example, with an aqueous solution of several percent tetramethylammonium hyroxide (™AH).

Another specific example of a suitable protected amino acid polymer, according to one or more embodiments of the invention, is Boc-Pro-Pro-Pro-Pro (C25H38N4O7; CAS Number 29804-52-2), where “Pro” stands for the amino acid praline. This amino acid polymer is commercially available from Sigma-Aldrich. The Boc protection of such a small molecule is sufficient to alter the solubility in a developer. Numerous other examples of analogous proteins are also contemplated.

As another option, in one or more embodiments of the invention, an amino acid polymer may be curdled, congealed, coagulated, or otherwise denatured as a result of exposure. The denaturation of the amino acid polymer may alter it or change its character or properties. In some cases, the denaturation may change the structure or conformation of the amino acid polymer.

Various different types of denaturation are contemplated. Chemical denaturation may involve exposing the amino acid polymer to an acid, water, an alcohol, or other denaturant. The denaturant may denature the amino acid polymer. In one or more embodiments of the invention, a PAG, a species capable of generating water upon exposure to radiation, a species capable of generating alcohol upon exposure to radiation, or a combination thereof, may be included in a photoresist composition in order to invoke a chemical denaturation of an amino acid polymer. Thermal denaturation may involve exposing the amino acid polymer to heat. In one or more embodiments of the invention, an infrared radiation may potentially be used for exposure in order to invoke a thermal denaturation of an amino acid polymer.

A wide variety of different types of amino acid polymers may be denatured. For example, a class of “albuminoids” may coagulate or flocculate under various denaturing treatments, such as, for example, exposure to heat, acid, alcohol, or water. Examples include albumen from egg whites, blood serum albumin, fibrin, and wheat gluten. For example, the albumin of egg whites may harden when heated or “cooked” and certain proteins in milk may coagulate when exposed to acid (e.g., lemon juice) or other coagulator. Other known forms of denaturation are also contemplated. The denaturation may be used either to decrease solubility in a developer or to increase solubility in a developer.

Other transformations are also contemplated. As one example, in one or more embodiments of the invention, photo-generated acids and/or bases may potentially disrupt salt bridges. As another example, in one or more embodiments of the invention, a protein may potentially be cleaved (e.g., upon photo-generated acid initiated activation of an enzyme) as a result of exposure. As another example, two shorter amino acid polymers may be joined (e.g., by reacting terminus groups and/or upon photo-generated acid initiated activation of an enzyme) as a result of exposure. Combinations of the aforementioned approaches are also contemplated.

In one embodiment of the invention, the resist compounds disclosed herein may be included in a resist composition with one or more other ingredients. Suitable ingredients include, but are not limited to, photo-acid generators (PAG) or other radiation-sensitive acid generator species that are capable of generating acids if exposed to radiation, acid scavengers or quenchers, surfactants, sensitizers, stabilizers, dyes, and combinations thereof.

Examples of suitable radiation-sensitive acid generators that are capable of generating an acid if exposed to radiation include, but are not limited to, iodonium salts, sulfonium salts, and other onium salts; bis(alkylsulfonyl) diazomethanes, bis(cycloalkylsulfonyl) diazomethanes, bis(arylsulfonyl) diazomethanes, and other diazomethanes; oxime sulfonates, nitrobenzylsulfonates, iminosulfonates, disulfones, and organic halogen compounds. Exemplary diazomethanes include, but are not limited to, bis(n-propylsulfonyl)diazomethane, bis(isopropylsulfonyl)diazomethane, bis(n-butylsulfonyl)-diazomethane, bis(isobutylsulfonyl)-diazomethane, bis(tert-butylsulfonyl)diazomethane, and other bis(alkylsulfonyl)diazomethanes each having a straight- or branched-chain alkyl group. Other exemplary diazomethanes include, but are not limited to, bis(cyclopentylsulfonyl)diazomethane, bis(cyclohexylsulfonyl) diazomethane, and other bis(cycloalkylsulfonyl)diazomethanes each having a cyclic alkyl group. Still other exemplary diazomethanes include, but are not limited to, bis(phenylsulfonyl)diazomethane, bis(p-methyphenylsulfonyl)diazomethane, bis(2,4-dimethylphenylsulfonyl)diazomethane, bis(p-methoxyphenylsulfonyl)diazomethane, and other bis(arylsulfonyl)diazomethanes each having a substituted or un-substituted phenyl group. These radiation-sensitive acid generators are also known in the arts as photoacid generators. According to various embodiments of the invention, the radiation-sensitive acid generators may be employed in the resist composition at a concentration of from about 0.5 to 15 wt %, or 1 to 10 wt %.

Some practitioners may find it appropriate to include one or more acid scavengers or quenchers in the composition. The acid scavengers, which are optional, may tend to improve resolution by adjusting or limiting the diffusion or mobility of the acid. Examples of suitable acid scavengers include, but are not limited to, nitrogen-containing compounds, such as amines, and other basic compounds. Exemplary amines include, but are not limited to, tri-n-butylamine, triethanolamine, and tris(2-methoxyethyl)amine. According to various embodiments of the invention, the acid scavengers may be employed at concentrations of from about 0 to 0 to 5 wt %, or 0 to 2 t %.

Some practitioners may find it appropriate to include one or more surfactants in the composition. The surfactants, which are optional, may tend to help improve the wetability of the resist, for example during immersion lithography, development, or both. However, it is contemplated that at least a portion of the surfactants may, at least potentially, contribute to scum. In one aspect, the attachment of the hydroxyl or other hydrophilic group to the protecting group may be useful to reduce the amount of surfactant. In various aspects, the surfactants may be employed at concentrations of from about 0 to 5 wt %, or 0 to 2 wt %.

Some practitioners may find it appropriate to include one or more sensitizers, stabilizers, and/or dyes in the composition. These components, which are optional, are often included at concentrations of less than about 0 to 5 wt %, or 0 to 2 wt %.

Typically, a solvent may be used to dilute the previously described resist compositions prior to use. For example, a composition of about 80 wt % solvent may be used. In one aspect, this may facilitate application of a smooth and uniform layer. A wide variety of organic solvents may potentially be employed. Depending upon the particular implementation, suitable solvents include, but are not limited to, ether solvents (e.g., ethylene glycol, dipropylene glycol, and propylene glycol methyl ether acetate), ester solvents (e.g., methyl lactate, ethyl acetate, and g-butyrolactone), ketone solvents (e.g., acetone, methyl isobutyl ketone, and 2-heptanone), and combinations thereof. The solvent is often added prior to shipping to the point of use, although this is not required. By way of example, a photoresist layer for 248 nm, 193 nm, and EUV (e.g., 13.5 nm) may use an amount of solvent in the approximate range of 1 to 10% or 1 to 5% by weight solid of the photoresist layer, although this is not required.

It is generally desirable for a photoresist to have good imaging resolution. It is also generally desirable to reduce the defectivity and collapse of the photoresists. Defectivity and collapse are believed to be due, at least in part, to non-uniform distribution of the components in the photoresist, which may tend to promote uneven performance within the photoresist and improper patterning of the photoresist. These may be especially desirable when imaging small structures/features, where the desirability of critical dimension control increases. As dimensions of the structures are scaled down, the amount of permissible error in the critical dimensions of the structures may tend to decrease. The line width roughness of the areas etched should also be minimal to accommodate for smaller dimensions and improved device performance.

Factors that may tend to affect the imaging resolution of the photoresist include the molecular weight and molecular weight distribution of the photoimageable species of the resist. Certain conventional photoresists are based on polymeric materials, such as, for example polyhydroxystyrene. The larger the molecular weight of the polyhydroxystyrene, the lower the resolution tends to be. In addition, the polyhydroxystyrene typically includes polymers of different molecular weight, giving the photoimageable species a molecular weight distribution. Furthermore, the different chains of the polyhydroxystyrene may tend to have different structures or conformations, for example stretched out, folded, etc. In other words, the polyhydroxystyrene molecules are not of identical size or shape. The lack of even distribution and uniformity in the size of the components may cause the photoacid to diffuse too much or too little before it is scavenged by a quencher. This may reduce the photospeed of the photoresist, and cause line roughness and loss of CD control.

In contrast, in one or more embodiments of the invention, amino acid polymers may be created to have relatively tight molecular weight distributions, although the scope of the invention is not so limited. For example, in one or more embodiments of the invention, each of the amino acid polymers may be the same single molecule of identical sequence and molecular weight, although the scope of the invention is not so limited. Furthermore, in such embodiments, the conformation or size and shape of the amino acid polymers may tend to be substantially similar due at least in part to the similar interactions between the different side groups attached to the backbones of identical sequence. Advantageously, using amino acid polymers of the same molecular weight, size, and shape may tend to help improve the imaging resolution of the photoresist. However, this is not required.

Other factors that may tend to limit the imaging resolution of a photoresist include imperfect distribution of photoresist components and excessive diffusion of species. By way of example, in one or more embodiments of the invention, a photoresist may include an amino acid polymer as a photoimageable species, a PAG, and a quencher. Improper mixing, chance, randomness, or other factors may provide that in some cases one or more of these components may be separated from each other by more than a desired distance. This may tend to adversely affect the resolution. For example, if the PAG is excessively removed from the amino acid polymer, the acid generated by the PAG upon exposure to radiation may not reach the amino acid polymer to transform it. As another example, if the quencher is excessively removed from the PAG, the acid generated by the PAG upon exposure to radiation may diffuse a greater distance than intended and transform amino acid polymers over a greater distance than intended. In general, this imperfect mixing represents a lack of perfect control, which may tend to adversely affect the imaging resolution of the photoresist.

In one or more embodiments of the invention, an amino acid polymer as a photoimageable species may be covalently bonded with, complexed with, or otherwise strongly chemically associated with (e.g., by stronger than normal intermolecular forces), one or more other interacting components of a photoresist composition. In one or more embodiments of the invention, the one or more other interacting components may include one or more of a PAG or other species capable of generating an acid upon exposure to actinic radiation, a quencher, a switch, or a combination thereof. In one or more embodiments of the invention, the one or more other interacting components of a photoresist composition may be covalently bonded to a sulfur-containing amino acid (e.g., cysteine or methionine) of the amino acid polymer, such as at a disulfide linkage.

In one or more embodiments of the invention, rather than bounding or tethering a specialized quencher, a basic amino acid of the amino acid polymer, such as, for example, arginine, lysine, histidine, or tryptophane, may itself serve as a bound quencher of the amino acid polymer. In one or more embodiments of the invention, acidic amino acids of the amino acid polymer, such as, for example, aspartic acid, asparagine, glutamic acid, and/or glutamine, may be used as solubility groups to help promote solubility in an aqueous potentially alkaline developer. In one or more embodiments of the invention, amino acids having hydrophobic bulky groups, such as, for example, phenylalanine and/or tryptophane may be used to render etch protection and/or solubility control.

Such predetermined association or preorganization may tend to help reduce the likelihood that interacting components are excessively removed from one another due to improper mixing, randomness, etc. Such predetermined association or preorganization may also tend to help reduce the diffusion of an acid or other species. The amino acid polymer may be larger than the acid or other species and less prone to diffusion. Advantageously, such preorganization of the amino acid polymer with the one or more other interacting components may tend to help improve photoresist imaging resolution. This preorganization may help to achieve a more “pixilated” exposure image.

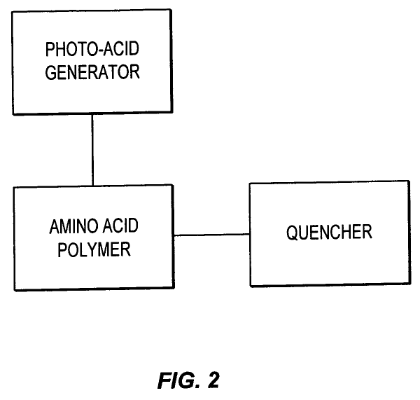

FIG. 2 is a block diagram of an amino acid polymer covalently bonded to both a photo-acid generator (PAG) and a quencher, according to one or more embodiments of the invention. In alternate embodiments, the amino acid polymer may be bonded to either one, but not both, of the PAG and the quencher. As another option, in one or more embodiments of the invention, the amino acid polymer may be bonded to another interacting component that interacts with the amino acid polymer in photolithography reactions or processes.

Patterned layers of amino acid polymer based photoresists may be used to form many different types of structures in the manufacture of integrated circuits. In one or more embodiments of the invention, a chemically amplified amino acid polymer based photoresist may be used to form lines for transistor gates. As another option, in one or more embodiments, a chemically amplified amino acid polymer based photoresist may be used to form trenches and/or vias for interconnect lines, such as, for example, by a conventional dual damascene method. As yet another option, in one or more embodiments of the invention, a chemically amplified amino acid polymer based photoresist may be used to form microelectromechanical devices (MEMS) or structures thereof, microfluidic devices or structures thereof, or other small structures. To further illustrate certain concepts, methods of using a chemically amplified amino acid polymer based photoresist to form vias for interconnect lines will be described in detail, although the scope of the invention is not limited to just this application.

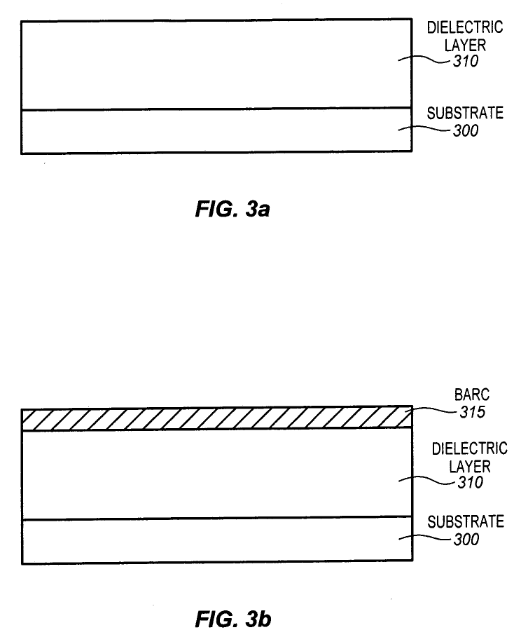

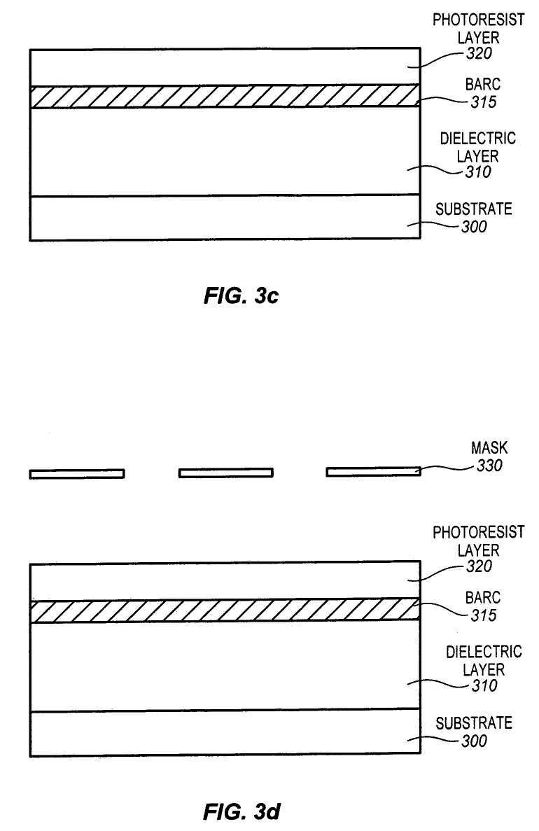

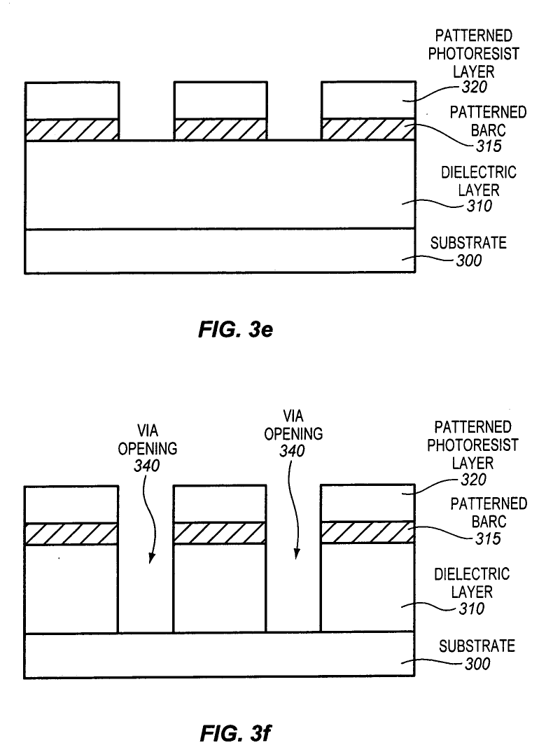

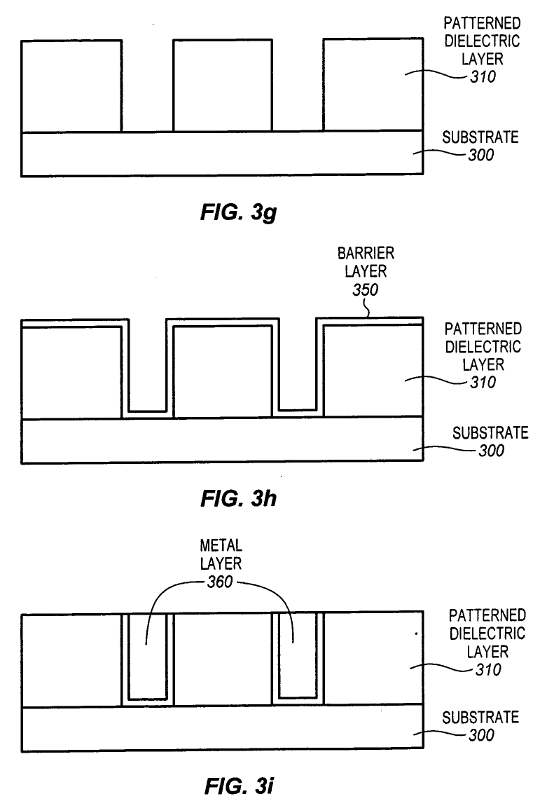

FIGS. 3a-3i are cross-sectional side views of different structures representing different stages of a method of forming vias, according to one or more embodiments of the invention. FIG. 3a is a view of a dielectric layer 310 formed over a substrate 300, according to one or more embodiments of the invention. The substrate may represent a general workpiece object encountered at various stages of a method of making an integrated circuit upon which a conductive interconnect may be formed. In one aspect, the substrate may include a semiconductor substrate. Examples of suitable semiconductor substrates include, but are not limited to, those of silicon, germanium, gallium arsenide, silicon-on-insulator, silicon on sapphire, and combinations thereof. The semiconductor substrate may have the form of a wafer.

The dielectric or insulating layer 310 is formed over a top surface of the substrate 300. In one or more embodiments of the invention, the dielectric layer may include an oxide of silicon, such as, for example, silicon dioxide (SiO2). As another option, in one or more embodiments of the invention, the dielectric layer may include a so-called low-k dielectric material having a dielectric constant that is lower than that of silicon dioxide. Examples of suitable low-k materials include, but are not limited to, carbon doped oxides (CDOs), polymeric low-k materials, and combinations thereof. Examples of suitable polymeric low-k materials include, but are not limited to: (1) those including poly(norbornene), such as those sold under the tradename UNITY™, distributed by Promerus, LLC; (2) those including polyarylene, such as those sold under the tradenames SiLK™ and GX-3™, distributed by Dow Chemical Corporation and Honeywell Corporation, respectively; (3) those including poly(aryl ether)-based materials, such as those sold under the tradename FLARE™, distributed by Honeywell Corporation; and (4) combinations thereof. The dielectric layer may have a thickness in the approximate range of 2,000 and 20,000 Angstroms.

FIG. 3b is a view after forming an optional bottom anti-reflective coating (BARC) 315 over the dielectric layer 310 of the structure of FIG. 3a. The BARC, which is optional, may help to reduce the amount of coherent light that re-enters a subsequently formed overlying photoresist layer 320 (see e.g., FIG. 3c) during irradiation and patterning of the photoresist layer. The BARC may optionally be omitted, such as, for example, in embodiments where non-light lithography radiation is used, or where the amount of reflection without the BARC is tolerable. The BARC may include an anti-reflective material. The anti-reflective material may include a base material and a radiation-absorbing additive. The base material may be an organic material, such as, for example, a polymer, which is capable of being patterned by etching or by irradiation and developing like a photoresist. As another option, the base material may be an inorganic material, such as, for example, silicon dioxide, silicon nitride, silicon oxynitride, or a combination thereof. By way of example, the radiation-absorbing additive may include an absorbant dye or pigment. The dye or pigment may be an organic or inorganic dye or pigment that absorbs light that is used during the exposure step of the photolithographic process.

FIG. 3c is a view after forming a photoresist layer 320 over the BARC of FIG. 3b. Examples of suitable approaches of forming the photoresist layer over the BARC, or alternatively over the dielectric layer, include, but are not limited to, spin coating, spray coating, roll coating, dip coating, painting, combinations thereof, and other application methods known in the arts. The photoresist layer may have a thickness sufficient to serve as a mask during a subsequent etching or implantation step. For example, the photoresist layer may have a thickness in the approximate range of 500 to 2500 Angstroms. Photoresist masks tend to be thickest for implantation purposes, thinner for contact e.g., via patterning, and thinner yet for gate patterning. The photoresist layer may be positive tone or negative tone. In a positive tone photoresist the area exposed to the radiation will define the area where the photoresist will be removed. In a negative tone photoresist the area that is not exposed to the radiation will define the area where the photoresist will be removed. In the illustrated embodiment, the photoresist layer is a positive tone photoresist.

In one or more embodiments of the invention, the photoresist layer may include an amino acid polymer based photoresist composition as disclosed elsewhere herein. In one or more embodiments of the invention, the amino acid polymer based photoresist composition may include an amino acid polymer protected with an acid labile protecting group and also including a photo-acid generator. In one or more embodiments of the invention, the amino acid polymer based photoresist composition may include an albuminoid and potentially a photo-acid generator or other denaturant.

In addition to the photoimageable species, the photoresist layer may also include one or more additives and a solvent. Examples of suitable additives for the photoresist layer include, but are not limited to, plasticizers, surfactants, adhesion promoters, acid amplifiers, dissolution inhibitors, dissolution promoters, sensitizers, stabilizers, acid scavengers, photobases, photodecomposable bases, solvents, dyes, and combinations thereof. The choice of solvent may depend on the polarity and architecture of the components used to form the photoresist. The amount of solvent may also dependent on the thickness of the photoresist and on the size of the wafer. Relatively less solvent may be used for a thicker photoresist layer, or relatively more solvent may be used for a thinner photoresist layer. Generally, the larger the wafer the more solvent that is used. By way of example, a photoresist layer for 248 nm, 193 nm, and EUV (e.g., 13.5 nm) may use an amount of solvent in the approximate range of 1 to 10% or 1 to 5% by weight solid of the photoresist layer, although this is not required.

FIG. 3d is a view after forming an optional mask 330 over or in position relative to the photoresist layer 320 of FIG. 3c. The mask may include a chrome on quartz patterned device or other known mask.

FIG. 3e is a view after exposing the photoresist layer 320 and the BARC layer 315 of FIG. 3d to patterned radiation. In various embodiments, the radiation may be 193 nm, 157 nm, deep ultraviolet (DUV), extreme ultraviolet (EUV), EUV having a wavelength of 13.5 nm, electron beam projection, ion beam, or other types of actinic radiation suitable for photolithography. Upon irradiation, the PAG within the photoresist layer may dissociate to form a photo-generated acid. The photo-generated acid may serve as a catalyst to deprotect and to change the solubility of the photoimageable species. The change in the solubility of the photoimageable species may allow the solvation of the photoimageable species and the removal of a positive photoresist by a developer. In a negative photoresist the acid may catalyze the cross-linking of the photoimageable species, and the developer that is subsequently applied may remove the portions of the negative photoresist that were not cross-linked.

Heating or a post-exposure bake may be performed on the exposed photoresist layer to enhance the mobility and hence the diffusion of the photo-generated acid within the photoresist layer. The post-exposure bake may be performed at a temperature in the approximate range of 90° C. to 150° C. and for a time in the approximate range of 30 to 90 seconds. The temperature and the time of the post-exposure bake may depend in part on the chemistry of the photoresist layer. The developer may be applied after the post-exposure bake to remove the desired portions of the photoresist layer. The developer may be a basic aqueous solution. Development is also occasionally known in the arts as resist strip.

FIG. 3f is a view after etching or otherwise forming via openings 340 through the dielectric layer 310 of FIG. 3e (after development) down to the substrate 300. Conventional process steps and chemistries may be used to etch through the dielectric layer. For example, a conventional anisotropic dry oxide etch process may be used. When the dielectric layer includes silicon dioxide, the via may be etched using a medium density magnetically enhanced reactive ion etching system (“MERIE” system) using fluorocarbon chemistry, or using other typical dry etch chemistries known to those skilled in the art. When the dielectric layer includes a polymeric material, a forming gas chemistry, such as one including nitrogen and either hydrogen or oxygen, may be used to etch the polymeric material, or the polymeric material may be etched using other dry etch chemistries known to those skilled in the art.

FIG. 3g is a view after removing the patterned photoresist layer 320 and the patterned BARC 315 of FIG. 3f. The photoresist layer and the BARC may be removed using a conventional ashing procedure. Alternatively, a resist strip procedure may be used.

FIG. 3h is a view after an optional barrier layer 350 has been formed over the top surface of the patterned dielectric layer 310 including on the sidewalls and bottom of the via openings of FIG. 3g. The barrier layer is optional and not required. A wide variety of barrier materials known in the arts may be used. Often, the barrier layer may include a refractory material, such as, for example, titanium nitride, tantalum nitride, or a combination thereof. The barrier layer may have a thickness in the approximate range of 100 to 500 Angstroms. The barrier layer may be deposited by chemical vapor deposition (CVD), sputter deposition, or atomic layer deposition (ALD). The barrier layer may help to prevent or at least reduce migration of metals, such as copper. These metals may tend to migrate out of the vias at temperatures used in semiconductor processing, which may potentially result in shorts.

FIG. 3i is a view after filling the via openings of FIG. 3h with metal via plugs 360. A metal layer may be deposited over the top surface of FIG. 3h. Examples of suitable metals include, but are not limited to, copper, copper alloy, gold, silver, aluminum, and combinations thereof. In one particular embodiment the metal includes copper. Copper may be deposited by electroplating or electroless plating. Suitable seed materials for the plating of copper include, but are not limited to, copper and nickel. The barrier layer may also serve as the seed layer. Alternatively, the metal may be formed by PVD, CVD, or other depositions. After deposition of this metal layer, planarization may be performed to achieve a planar surface. For example, chemical mechanical planarization (CMP) may be performed.

A description of the formation of a single dielectric layer and vias there through has been provided. However, it is to be appreciated that in some cases similar methods may be repeated to form multiple levels of conductive and insulating layers.

There are a number of other potential advantages to using amino acid polymers as photoimageable species in photoresists. One potential advantage of the use of amino acid polymer-based photoresists is that proteins and peptides have been widely studied. There is much experimental data and many tools of protein analysis. This large amount of knowledge and infrastructure may be adapted for photolithography.

Another potential advantage is that certain conventional photoresists do not readily degrade in nature. In contrast, various amino acid polymers suitable for embodiments of the invention may tend to degrade more readily in nature. In one or more embodiments of the invention, a developer may be contacted with an exposed amino acid based photoresist layer, some of the amino acid polymer may be dissolved in the developer, and the spent developer solution including dissolved amino acid polymer may potentially be biologically treated using microorganisms.

Another potential advantage is that sophisticated functionalities may be synthesized in amino acid polymers taking advantage of the vast developments in protein synthesis. Such sophisticated functionalities and structural control may tend to be much more difficult to synthesize by non-amino acid routes.

Having been generally described, the following examples are given as particular embodiments of the invention, to illustrate some of the properties and demonstrate the practical advantages thereof, and to allow one skilled in the art to better utilize the invention. It is understood that these examples are to be construed as merely illustrative.

### EXAMPLE 1

### Preparation of Positive Tone tBOC Protected Polytyrosine Resist Composition

This example demonstrates how to prepare a positive tone tBOC protected polytyrosine resist composition, according to one particular embodiment of the invention. First, the tBOC protected polytyrosine may be prepared. About 70 mg of Polytyrosine (with a molecular weight of 40 kD) was dissolved in about 0.7 ml dry dimethylformamide. To this mixture was added about 180 mg (2 eq) ditbutylcarbonate dropwise over about 2 min and then about 0.25 ml triethylamine. The suspension was then allowed to stand at room temperature with occasional agitation for about 48 hours. The material was diluted with about 5 ml water and the precipitate was filtered and washed twice with about 5 ml water each time, and then dried in vacuum to 80 mg. This is how to prepare the tBOC protected polytyrosine. The tBOC protected polytyrosine was dried, mixed with about 8 mg triphenylsulfonium nonafluorobutylsulfonate (TPS). The TPS served as a photo-acid generator. Other photo-acid generators may alternatively be used. This mixture was dissolved in a solution of about 3 grams of 80% propyleneglycol monomethyl ether (PGME) and about 20% propyleneglycol monomethyl ether acetate (PGMEA). The PGME/PGMEA had less than about 2% beta isomer. It is contemplated that analogous photoresist compositions may be prepared with other known proteins having an acid labile dissolution inhibitor or protecting group.

### EXAMPLE 2

### Preparation of Negative Tone Albumin Resist Composition

This example demonstrates how to prepare a negative tone albumin resist composition, according to one particular embodiment of the invention. About 100 mg of albumin was combined with about 10 mg of triphenylsulfonium nonafluorobutylsulfonate (TPS). The TPS served as a photo-acid generator. Other photo-acid generators may alternatively be used. The combination was dissolved in about 2.2 g of water. It is contemplated that analogous photoresist compositions may be prepared with other known albuminoid-type proteins.

### EXAMPLE 3

### Forming a Layer of a Photoresist

This example demonstrates how to form a layer of a photoresist, according to one particular embodiment of the invention. Photoresist compositions prepared according to Examples 1 and 2 were spun on a substrate with a spin speed of about 500-2000 rpm for about 10 to 90 seconds. The substrate was an HMDS wafer, although other substrates are also suitable. This formed photoresist layers with a thickness in the approximate range of 100 to 200 nm. The substrates having the tBOC protected polytyrosine resist layers were then baked at a temperature of about 100° C. for about a minute.

### EXAMPLE 4

### Prospective Example of Photographic Exposure of Albumin

This prospective example demonstrates how to expose an albumin-based photoresist layer, such as, for example, one formed according to Example 3. The albumin may have a starting protein structure in the photoresist layer based on the chemical interactions within and between proteins. Typically, the albmin may be raveled up into a compact structure. The photoresist layer may be exposed to actinic radiation suitable to decompose the TPS or other PAG through a patterned mask. In one aspect, the actinic radiation may include 193 nm radiation. The actinic radiation may cause the PAG to decompose or otherwise generate an acid. The acid may denature or otherwise react with the albumin in the exposed portions of the photoresist layer. The denaturation or other reaction may change or modify the starting protein structure by changing or modifying the chemical interactions within and between proteins. For example, the acid may conceptually unravel the proteins or decompact the structure. The transformation may at least conceptually be similar to the transformation that may occur when a white of an egg is cooked to hardening. This transformation of the albumin may occur primarily in the exposed portions of the layer. In one or more embodiments of the invention, a post-exposure bake may be used to complete the transformation, although this is not required. Other examples are contemplated in which the albumin is replaced by other albuminoid-type proteins or fragments or derivatives thereof, or other amino acid polymers capable of coagulating, flocculating, or otherwise denaturing.

### EXAMPLE 5

### Prospective Example of Developing an Exposed Albmin-Based Photoresist Layer

This prospective example demonstrates how to develop an exposed albumin-based photoresist layer, such as, for example, one formed according to Example 4. The exposed albumin-based photoresist layer may be contacted with a developer. The developer may dissolve, wash away, or otherwise remove the un-exposed portions of the albumin-based photoresist layer. This may leave the exposed portions of the photoresist layer as a patterned layer. This patterned layer may be used for etching or implantation, as disclosed elsewhere herein. Other examples are contemplated in which the albumin is replaced by other albuminoid-type proteins or fragments or derivatives thereof, or other amino acid polymers capable of coagulating, flocculating, or otherwise denaturing.

### EXAMPLE 6

### Prospective Example of Photographic Exposure of tBOC Protected Polytyrosine Resist Layer

This prospective example demonstrates how to expose an tBOC protected polytyrosine resist, such as, for example, one formed according to Example 3. The photoresist layer may be exposed to actinic radiation suitable to decompose the TPS or other PAG through a patterned mask. In one aspect, the actinic radiation may include 193 nm radiation. The actinic radiation may cause the PAG to decompose or otherwise generate an acid. The acid may catalytically cleave the tBOC groups from the polytyrosine resist in a process of deprotection. The removal of the tBOC protection may increase the solubility of the polytyrosine resist in the exposed portions of the photoresist layer in a developer. In one or more embodiments of the invention, a post-exposure bake may be used to complete the transformation, although this is not required. Other examples are contemplated in which the tBOC protected polytyrosine resist is replaced by other acid labile protecting group protected amino acid polymers. One notable example is Boc-Pro-Pro-Pro-Pro.

### EXAMPLE 7

### Prospective Example of Developing an Exposed tBOC Protected Polytyrosine Resist Layer

This prospective example demonstrates how to develop an exposed tBOC protected polytyrosine resist, such as, for example, one formed according to Example 6. The exposed photoresist layer may be contacted with a developer. The developer may dissolve, wash away, or otherwise remove the un-exposed portions of the tBOC protected polytyrosine resist layer. This may leave the exposed portions of the photoresist layer as a patterned layer. This patterned layer may be used for etching or implantation, as disclosed elsewhere herein. Other examples are contemplated in which the tBOC protected polytyrosine resist is replaced by other acid labile protecting group protected amino acid polymers. One notable example is Boc-Pro-Pro-Pro-Pro.

In the description above, for the purposes of explanation, numerous specific details have been set forth in order to provide a thorough understanding of the embodiments of the invention. Other embodiments may be practiced without some of these specific details. The invention is not limited to the embodiments described, but may be practiced with modification and alteration within the spirit and scope of the appended claims. The description is thus to be regarded as illustrative instead of limiting. In other instances, well-known structures, formulas, and techniques have been shown in block diagram form or without detail in order not to obscure the understanding of this description.

Particular examples of methods have been described in order to illustrate certain concepts. However, the scope of the invention is not limited to these particular methods. In some cases, operations may be added to and/or removed from the methods. In some cases, operations may be performed in different order. Other modifications and adaptations are also possible. The particular embodiments are not provided to limit the invention but to illustrate it. The scope of the invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that a claim require more features than are expressly recited therein. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

In the claims, any element that does not explicitly state “means for” performing a specified function, or “step for” performing a specified function, is not to be interpreted as a “means” or “step” clause as specified in 35 U.S.C. Section 112, Paragraph 6. In particular, any use of “step of” in the claims herein is not intended to invoke the provisions of 35 U.S.C. Section 112, Paragraph 6.

1-9. (canceled)

10. A photoresist solution comprising:
a photo-acid generator dissolved in the photoresist solution; and
an amino acid polymer dissolved in the photoresist solution.

11. The photoresist solution of claim 10, wherein the amino acid polymer comprises an acid labile protecting group.

12. The photoresist solution of claim 11, wherein the acid labile protecting group comprises a t-butoxycarbonyl group.

13. The photoresist solution of claim 11, wherein the amino acid polymer comprises polytyrosine.

14. The photoresist solution of claim 10, wherein the amino acid polymer comprises an albuminoid.

15. The photoresist solution of claim 10, wherein the photo-acid generator is bound to the amino acid polymer.

16. The photoresist solution of claim 15, wherein the photo-acid generator is bound to the amino acid polymer at a sulfur of a sulfur-containing amino acid.

17. The photoresist solution of claim 10, further comprising a quencher bound to a sulfur of a sulfur-containing amino acid of the amino acid polymer.

18. The photoresist solution of claim 10, wherein a concentration of the amino acid polymer in the composition is at least 80wt%, wherein a concentration of the photo-acid generator in the composition is in the range of 0.5 to 15wt%.

19. The photoresist solution of claim 10, further comprising:
an acid scavenger;
a surfactant;
a sensitizer; and
a stabilizer.

20-22. (canceled)

23. The photoresist solution of claim 10, further comprising a solvent to dilute the photoresist solution.

24. The photoresist solution of claim 10, wherein the photoresist solution is not on a substrate.

25. A method comprising forming a layer of the photoresist solution of claim 10 over a substrate.

26. A substrate having a layer thereon that is formed from the photoresist solution of claim 10.
